(19) United States
(12) Patent Application Publication
(10) Pub. No.: US 2010/0189140 A1
(43) Pub. Date: Jul. 29, 2010

(54) Laser Diode End Pumped Monoblock Laser

(75) Inventors: John E. Nettleton, Fairfax Station, VA (US); Dallas N. Barr, Woodbridge, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES OF AMERICA, AS REPRESENTED BY SECRETARY OF THE ARMY, Fort Belvoir, VA (US)

(21) Appl. No.: 12/652,993

(22) Filed: Jan. 6, 2010

Related U.S. Application Data
(60) Provisional application No. 61/147,505, filed on Jan. 27, 2009.

(51) Int. Cl. H01S 3/11

(52) U.S. Cl. 372/10

(57) ABSTRACT

A monoblock laser that has a laser cavity having a laser gain material, a Q switch optically coupled to the laser gain material, and an OPO material optically coupled to the Q switch. A laser pump is spaced from an end of the laser cavity. The laser pump has an output that is absorbed along an entire length of the laser cavity providing athermal operation without temperature control of the laser pump over the operating range of the monoblock laser.

### CROSS-REFERENCE TO RELATED APPLICATIONS

This application claims benefit of Provisional Application No. 61/147,505, filed Jan. 27, 2009.

### GOVERNMENT INTEREST

The invention described herein may be manufactured, used, sold, imported, and/or licensed by or for the United States Government.

### FIELD OF THE INVENTION

The invention relates to monoblock lasers.

### BACKGROUND OF THE INVENTION

Monoblock laser cavities are generally known in the art. Prior art monoblock laser cavities may be pumped using a flash lamp side pump. Typically, the flash lamps require a separate reflector cavity for supplying an output to the laser cavity. Additionally, flash lamps require large amounts of energy from a power supply or battery and require longer periods of time to allow for charging of a flash lamp before a discharge. Flash lamps also add weight and size to the overall structure of a monoblock laser.

Diode arrays are also known in the art for use as laser pumps for various laser cavities. However, such diodes generally have a temperature-controlled module or structure associated with the diodes to assure the wavelength of the diode does not shift with a change in the temperature. Thus, temperature controlled structures add to the overall cost, size and weight, as well as the power necessary to operate such a device.

There is therefore a need in the art for an improved monoblock laser that does not require temperature control of a laser pump and has an overall reduction in size compared to prior art devices. Additionally, there is a need in the art for a monoblock laser having an improved beam quality across a wide operational temperature range. There is also a need in the art for a monoblock laser that is energy efficient and has an improved repetition rate in comparison to prior art devices.

### SUMMARY OF THE INVENTION

In one aspect, there is disclosed a monoblock laser that has a laser cavity having a laser gain material, a Q switch optically coupled to the laser gain material, and an optical parametric oscillator (OPO) material optically coupled to the Q switch. A laser pump is spaced from an end of the laser cavity. The monoblock laser operates athermally without temperature control of the laser pump over the operating range of the monoblock laser.

In another aspect, there is disclosed a monoblock laser having a laser cavity including a laser gain material, a Q switch optically coupled to the laser gain material, and an OPO material optically coupled to the Q switch. A laser pump is spaced from an end of the laser cavity. The laser pump has an output that is absorbed along an entire length of the laser cavity providing athermal operation without temperature control of the laser pump over the operating range of the monoblock laser.

In another aspect, there is disclosed a process for making a monoblock laser that includes providing a laser cavity having a laser gain material, a Q switch optically coupled to the laser gain material, and an OPO material optically coupled to the Q switch. A laser pump is positioned such that it is spaced from an end of the laser cavity. The monoblock laser operates athermally without temperature control of the laser pump over the operating range of the monoblock laser.

### BRIEF DESCRIPTION OF THE DRAWINGS

FIG. 1 is a plan view of a monoblock laser cavity including the laser gain material, Q switch, OPO material, and the coatings applied to the various components;

FIG. 2 is a side view of a monoblock laser cavity including the laser gain material, Q switch, OPO material, and the coatings applied to the various components;

FIG. 3 is a diagram of an output beam profile of a side pumped monoblock laser; and

FIG. 4 is an output beam profile of an end pumped monoblock laser cavity according to the invention.

### DETAILED DESCRIPTION OF THE PREFERRED EMBODIMENTS

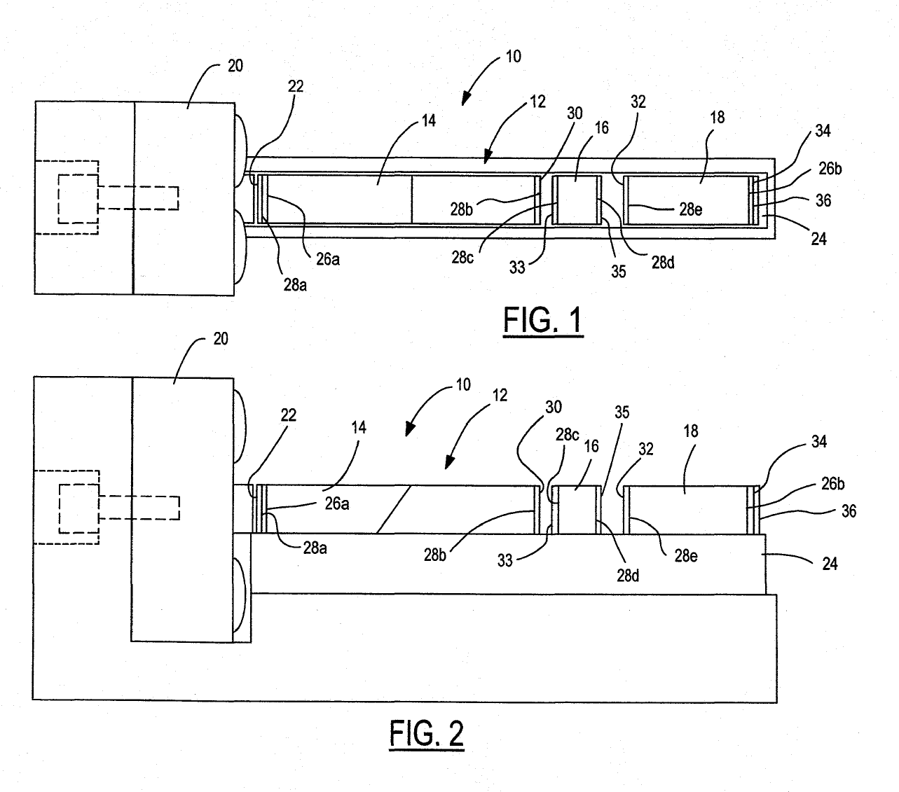

Referring to FIGS. 1 and 2, there is shown a monoblock laser 10 according to one embodiment. The monoblock laser 10 includes a laser cavity 12 having a laser gain material 14, a Q switch 16 optically coupled to the laser gain material 14, and an OPO material 18 optically coupled to the Q switch 16. A laser pump 20 is spaced from an end 22 of the laser cavity 12. The monoblock laser 10 operates athermally without temperature control of the laser pump 20 over the operating range of the monoblock laser 10.

In one aspect, an output of the laser pump 20 is absorbed along an entire length of the laser cavity 12, as it is positioned on the end 22 of the laser cavity 12 proximate the laser gain material 14. The laser pump 20 may be a diode array having a plurality of diodes having varying output wavelengths. In one aspect, the diode array may be sized relative to the end 22 of the laser gain material 14 to allow close coupling of the laser pump 20 with the laser gain material 14 such that an output of the laser diode array is directly injected into the laser cavity 12. In this manner, reflectors and other structures associated with the prior art designs may be eliminated, reducing the overall size and complexity of the monoblock laser 10.

As stated above, the laser pump 20 is spaced from an end 22 of the laser cavity 12. In one aspect, the laser pump 20 may be spaced from 0.4 to 1.5 mm from the end 22 of the laser cavity 12. The spacing of the laser pump 20 from the monoblock laser cavity 12 allows for the pump beams to expand and uniformly fill the laser crystal preventing hot spots from forming which may cause premature firing of the laser cavity 12, resulting in reduced output pulse energy associated with a beam discharge from the monoblock laser 10.

As stated previously, the output of the laser pump 20 is absorbed along an entire length of the laser cavity 12 allowing operation of the monoblock laser 10 over a broad temperature range without temperature control of the laser pump 20. Elimination of the temperature control of the laser pump 20 results in reductions in costs, as well as reductions in size, weight and power consumption of the monoblock laser 10. In one aspect, the athermal operation or operation without temperature control of the laser pump 20 provides significant performance improvements over prior art designs while maintaining a compact and small size of the monoblock laser 10.

In one aspect, the laser gain material 14, Q switch 16 and OPO material 18 are positioned on a substrate 24, as shown in FIGS. 1 and 2. In one aspect, the laser gain material 14 may be a neodinium, yitrium, aluminum-garnet or (ND:YAG) material or the like. It should be realized that other laser gain materials may be utilized. For example materials such as, ND:YLF, ND vanadate, KGW and gain materials that generate outputs of from 1 to 1.2 microns in wavelength or the like may also be utilized. The Q switch 16 may be formed of a suitable material, such as Cr (4+):YAG. The OPO material 18 may be formed of KTiOPO₄ (KTP) or KTiOASO₄ (KTA). The substrate 24 may be formed of an undoped yitrium aluminum garnet (YAG) material. It should be realized that various other materials known in the art for use as a gain material, Q switch or OPO may be utilized by the invention.

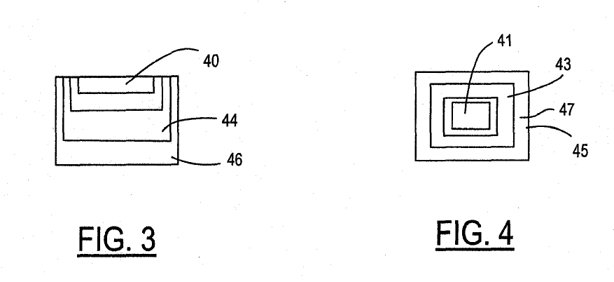

Referring to FIGS. 3 and 4, there is shown a beam profile of a side pumped and end pumped monoblock laser, respectively. As can be seen in FIG. 3, the profile of the side pumped beam is not uniform and fully formed. The higher intensity core 40 is surrounded on one side by lower intensity regions 42 and 44. The beam profile of the end pumped design of FIG. 4 includes a fully formed high intensity core 41 surrounded uniformly by lower intensity regions 43 and 45 providing a better quality beam.

In one aspect, the monoblock laser 10 may provide a beam at an eye-safe wavelength. The wavelength may be of about 1.5 microns. Again referring to FIGS. 1 and 2, the various components of the monoblock laser 10 may include coatings to optimize the absorption of the output of the laser pump 20 and provide for a beam at a specified eye-safe wavelength. In one aspect, the first end 22 of the laser gain material 14 may include a coating of a high reflective material 26a, as well as a coating of an anti-reflective material 28a. The highly reflective material 26a may have an associated wavelength of about 1.5 and 1.06 micrometers, while the anti-reflective coating 28a has an associated wavelength of about 808 nanometers. Additionally, a second end 30 of the laser gain material 14 may include an anti-reflective coating 28b, having an associated wavelength of about 1.5 and 1.06 micrometers. The first 33 and second 35 ends of the Q switch 16 may include an anti-reflective coating 28c and 28d having an associated wavelength of about 1.06 and 1.5 micrometers. The first end 32 of the OPO material 18 may also include an anti-reflective coating 28e having an associated wavelength of approximately 1.06 and 1.5 micrometers. A second end 34 of the OPO material 18 may include a highly reflective coating 26b at an associated wavelength of 1.06 micrometers. Additionally, on the second end 34 of the OPO material 18, there may be included an output coupler or partial reflector 36 at an associated wavelength of 1.5 micrometers for providing an eye-safe wavelength.

The monoblock laser 10 may be suitable for use in compact laser rangefinder systems having significant improvements over prior art laser rangefinders. The beam produced by the monoblock laser 10 displays a better quality output in comparison to side pump prior art designs. Additionally, the monoblock laser 10 includes components such as the laser pump 20, laser gain material 14, Q switch 16, and OPO material 18 that are locked into position after manufacture. In this manner, the optical laser cavity does not need to be aligned after it has been fabricated and results in an increased brightness of the monoblock laser 10 in comparison to a misaligned laser. The improved beam quality may be used to accurately determine a distance from an object in a laser range finder. Additionally, a laser rangefinder including the monoblock laser 10 may display improvements over current prior art flash lamp designs having improvements over the repetition rate in which a laser rangefinder may be discharged. For example, prior art flash lamp designs often require significant time periods to initially charge a capacitor from a cold start and require several seconds between ranges. Utilizing the monoblock laser 10, as described above, provides for much smaller charging times and allows for less than one second between ranges.

There is also disclosed a process for making a monoblock laser that includes providing a laser cavity 12 that has a laser gain material 14, a Q switch 16 optically coupled to the laser gain material 14, and an OPO material 18 that is optically coupled to the Q switch 16. A laser pump 20 is positioned such that it is spaced from an end 22 of the laser cavity 12, such that the monoblock laser 10 operates athermally without temperature control of the laser pump 20 over the operating range of the monoblock laser 10.

The process may also include sizing a diode array relative to the end 22 of the laser gain material 14 to allow for close coupling of the laser pump 20 with the laser gain material 14, such that an output of the laser diode array is directly injected into the laser cavity 12.

The process of the invention may also include applying the various coatings, as described above, and may include the step of applying highly reflective materials 26 and anti-reflective materials 28 on the various components as described above.

The invention has been described in an illustrative manner. It is to be understood that the terminology which has been used is intended to be in the nature of words of description, rather than limitation. Many modifications and variations of the invention are possible in light of the above teachings. Therefore, within the scope of the appended claims, the invention may be practiced other than as specifically described.

We claim:

1. A monoblock laser comprising:
a laser cavity having a laser gain material, a Q switch optically coupled to the laser gain material, and an OPO material optically coupled to the Q switch;
a laser pump spaced from an end of the laser cavity wherein the monoblock laser operates athermally without temperature control of the laser pump over the operating range of the monoblock laser.

2. The monoblock laser of claim 1 wherein an output of the laser pump is absorbed along an entire length of the laser cavity.

3. The monoblock laser of claim 1 wherein the laser pump is a diode array.

4. The monoblock laser of claim 3 wherein the diode array is sized relative to the end of the laser gain material allowing close coupling of the laser pump with the laser gain material wherein an output of the laser diode array is directly injected into the laser cavity.

5. The monoblock laser of claim 1 wherein the laser pump is spaced from 0.4 to 1.5 millimeters from the end of the laser cavity.

6. The monoblock laser of claim 3 wherein the diode array includes a plurality of diodes having varying output wavelengths.

7. The monoblock laser of claim 1 wherein the laser gain material, Q switch and OPO material are positioned on a substrate.

8. The monoblock laser of claim 7 wherein the laser gain material is Nd:YAG, the Q switch is formed of Cr (4+):YAG, the OPO material is formed of KTP and the substrate is formed of un-doped YAG.

9. The monoblock laser of claim 1 wherein a first end of the laser gain material includes a coating of a highly reflective material and an anti-reflective material.

10. The monoblock laser of claim 1 wherein a second end of the laser gain material includes an anti-reflective coating.

11. The monoblock laser of claim 1 wherein a first end of the OPO material includes an anti-reflective coating.

12. The monoblock laser of claim 1 wherein a first and second end of the Q switch includes an anti-reflective coating.

13. The monoblock laser of claim 1 wherein a second end of the OPO material includes a highly reflective coating and an output coupler.

14. A monoblock laser comprising:
a laser cavity having a laser gain material, a Q switch optically coupled to the laser gain material, and an OPO material optically coupled to the Q switch;
a laser pump spaced from an end of the laser cavity wherein an output of the laser pump is absorbed along an entire length of the laser cavity providing athermal operation without temperature control of the laser pump over the operating range of the monoblock laser.

15. A process for making a monoblock laser comprising:
providing a laser cavity having a laser gain material, a Q switch optically coupled to the laser gain material, and an OPO material optically coupled to the Q switch;
positioning a laser pump spaced from an end of the laser cavity wherein the monoblock laser operates athermally without temperature control of the laser pump over the operating range of the monoblock laser.

16. The process for making a monoblock laser of claim 15 wherein an output of the laser pump is absorbed along an entire length of the laser cavity.

17. The process for making a monoblock laser of claim 15 wherein the laser pump is a diode array and is sized relative to the end of the laser gain material allowing close coupling of the laser pump with the laser gain material wherein an output of the laser diode array is directly injected into the laser cavity.

18. The process for making a monoblock laser of claim 15 including applying a coating of a highly reflective material on a first end of the laser gain material and applying an anti-reflective material to the highly reflective material, applying a coating of an anti-reflective material on a second end of the laser gain material, applying a coating of an anti-reflective material on a first end of the OPO material and applying a coating of a highly reflective material and output coupler on a second end of the OPO material.

19. The process for making a monoblock laser of claim 15 wherein the laser pump is spaced from 0.4 to 1.5 millimeters from the end of the laser cavity.
